(19) United States
(12) Patent Application Publication
(10) Pub. No.: US 2006/0272233 A1
(43) Pub. Date: Dec. 7, 2006

(54) Stained glass porch system

(76) Inventor: Leslie Woolfrey, Fredericksburg, VA (US)

Correspondence Address: KLIMA LAW OFFICES, P.L.L.C., P.O. Box 2855, Stafford, VA, 22555-2855, US

(21) Appl. No.: 11/103,428

(22) Filed: Apr. 12, 2005

(51) Int. Cl. B44F 1/06; E06B 1/38

(52) U.S. Cl. 52/201; 428/38

(57) ABSTRACT

A stained glass porch system including multiple posts supporting a beam defining multiple openings, and a plurality of spandrel device mounted within the openings and in contact with the beam.

### FIELD OF THE INVENTION

The present invention is directed to a stained glass porch system.

### BACKGROUND OF THE INVENTION

The use of stained glass, in particular leaded stained glass for windows in buildings, particularly in churches is old. In these applications, a stained glass window is made by connecting different size, shape, color and/or textured stained glass pieces together using lead metal. The typical stained glass window is supported around its outer edges by the wood frame of the window.

More recently, there has been a renewed interest in stained glass for use in homes and retail businesses. For example, the front doors of many homes have stained glass windows panels in the doors themselves or in side lites or transom lites located above the door. In most applications the original see-through clear glass panel is replaced with a stained glass panel in the conventional frame.

The present invention involves the novel combination of stained glass devices and a porch of a home or commercial building. The stained glass porch system according to the present invention provides a unique look to both the porch and the home or commercial building.

### SUMMARY OF THE INVENTION

The first object of the present invention is to provide a stained glass porch system.

A second object of the present invention is to provide a stained glass porch system including a porch having multiple posts supporting a beam defining multiple openings, and a plurality of stained glass spandrel devices mounted in the openings between adjacent posts or the facade of the building and a post.

A third object of the present invention is to provide a stained glass porch system including a porch having multiple posts supporting a beam defining a plurality of openings, and a plurality of low profile rectangular-shaped stained glass spandrel devices mounted in the openings and extending between adjacent posts or the facade of the building and a post.

A fourth object of the present invention is to provide a stained glass porch system, said system comprising a porch having a plurality of vertical posts supporting a horizontal beam and defining multiple openings; a plurality of spandrel devices each mounted within one of the openings and extending between a pair of adjacent posts and in contact with a lower edge of the beam, the spandrel devices each including a low profile rectangular-shaped frame including four (4) frame members mitered and joined together at comers of the rectangular-shaped frame, the frame members being grooved along the length of one edge to provide a receiver for edges of a plurality of stained glass panels; a plurality of stained glass panels disposed side-by-side in a horizontal linear array within the rectangular frame; a seal provided in the grooves of the frame members of the rectangular frame, and provided between edges of the stained glass panels and an inner edges of the grooves; and a plurality of vertical dividers extending between an upper frame member and lower frame member of the rectangular frame, and connecting adjacent stained glass panels together, wherein the plurality of spandrel devices are coordinated by color and stained glass design to create an overall unique coordinated decorative look to said porch and building.

A fifth object of the present invention is to provide a stained glass porch system wherein the frame members are made from a polyurethane material.

A sixth object of the present invention is to provide a stained glass porch system wherein said stained glass panels are each defined by a single piece of rectangular-shaped stained glass.

A seventh object of the present invention is to provide a stained glass porch system wherein adjacent stained glass panels are different colored from panel-to-panel.

A eighth object of the present invention is to provide a stained glass porch system wherein the stained glass panels are square.

A ninth object of the present invention is to provide a stained glass porch system wherein the stained glass panels are colored and square.

A tenth object of the present invention is to provide a stained glass porch system wherein one or more of the stained glass panels have multiple different colored stained glass areas providing a unique stained glass design.

A eleventh object of the present invention is to provide a stained glass porch system wherein adjacent stained glass panels are coordinated in color and design from panel-to-panel to create a coordinated color design for the particular spandrel device.

A twelfth object of the present invention is to provide a stained glass porch system wherein the stained glass panels are leaded stained glass panels.

A thirteenth object of the present invention is to provide a stained glass porch system wherein the stained glass panels are leaded stained glass panels.

A fourteenth object of the present invention is to provide a stained glass porch system including multiple spandrel devices provided on a front of the porch.

A fifteenth object of the present invention is to provide a stained glass porch system including multiple spandrels provide on both a front and side of the porch.

A sixteenth object of the present invention is to provide a stained glass porch system wherein the rectangular frame is colored coordinated with said posts of the porch.

A seventeenth object of the present invention is to provide a stained glass porch system wherein the dividers are metal H-shaped track dividers.

A eighteenth object of the present invention is to provide a stained glass porch system including one or more openings provided with a set of triangular-shaped brackets mounted to a pair of adjacent posts and the beam.

A nineteenth object of the present invention is to provide a stained glass porch system wherein each the triangular-shaped bracket, includes two (2) equal length bracket members mitered and joined together to provide a square comer; a third longer length bracket member mitered, overlapping and joining ends of the equal length bracket members to form two acute angle comers, the bracket members grooved along the length of one edge to provide a receiver for edges of a triangular-shaped stained glass panel; and a triangular-shaped stained glass panel disposed within the bracket members, wherein the third longer length bracket member protects a hypotenuse edge of the stained glass panel.

The present invention is directed to a stained glass porch system. The system according to the present invention includes a porch having a plurality of vertical posts supporting a horizontal beam defining a plurality of openings, and a plurality of spandrel devices mounted within the openings and extending between adjacent posts or the facade of the building and a post, and preferably in contact with the beam.

The porch preferably includes a plurality of vertical posts located along the front elevation of the house or building. A plurality of spandrel devices according to the present invention can be installed or mounted within the openings defined by adjacent vertical posts. In some embodiments, additional spandrel devices according to the present invention are mounted from the posts to the facade of the house or building on one or more side elevations of the porch. In other embodiments, the porch includes both front vertical posts and side vertical posts allowing spandrel devices according to the present invention to be mounted between adjacent vertical posts on both the front elevation and side elevation of the porch. Preferably, all spandrel devices are located at the same height on the porch.

The spandrel devices according to the present invention preferably include a rectangular-shaped frame, more preferably a low profile rectangular-shaped frame. The frame is preferably made out of a polyurethane material. For example, stock rectangular-shaped cross-sectional stock polyurethane material can be used for making the frame. The frame includes four (4) separate frame members mitered and joined together to provide four (4) comers of the frame. The frame members are provided with a groove on one side and extending along the length thereof to define a receiver for edges of the stained glass panels.

The spandrel devices according to the present invention preferably include a plurality of stained glass panels connected together in a one (1) dimensional horizontal array disposed within the frame. For example, the stained glass panels can be single rectangular-shaped stained glass pieces connected together by vertical dividers. In another preferred embodiment, the stained glass panels are each a different color. In a preferred embodiment, the glass panels are square-shaped. In other embodiments, the glass panels are made from multiple stained glass pieces joined together to form the stained glass panels. In a more preferred embodiment, adjacent stained glass panels are coordinated in color, texture, and stained glass design so that the entire spandrel device is a coordinated color and design unit. Even further, all of the spandrel devices are preferably coordinated in color, texture and stained glass design to provide an overall coordinated look and appearance to the porch and house or building.

The stained glass porch system according to the present invention can utilize all spandrel devices according to the present invention, all bracket devices according to the present invention, or a combination thereof.

The stained glass bracket devices according to the present invention are triangular-shaped bracket devices. For example, the stained glass bracket device can include a pair of equal length frame members mitered and joined together to form a square comer, and a longer frame member mitered and joined to the ends of the equal length frame members forming a triangular-shaped frame. In a preferred embodiment, the longer frame member overlaps the ends of the two equal length frame members and protects a hypotenuse side of a triangular-shaped stained glass panel.

In a preferred embodiment of the spandrel devices and bracket devices according to the present invention, a seal is provided in the groove receiver of the frame members between the edge of the stained glass panel and an inner edge of the receiver. This seal positively connects and seals the edge of the stained glass panels to the frame members, and prevents damage or breakage of the edge thereof.

### BRIEF DESCRIPTION OF THE DRAWINGS

FIG. 1 is a perspective view of a stained glass porch system according to the present invention.

FIG. 2 is an interior perspective of another stained glass porch system according to the present invention.

FIG. 3 is a perspective view of a spandrel device according to the present invention.

FIG. 4 is a broken away perspective view of a comer portion of the frame of the spandrel device shown in FIG. 3.

FIG. 5 is a traverse cross-sectional view of a frame member of the spandrel device, as indicated in FIG. 3, showing a detail of the foam seal.

FIG. 6 is a transverse cross-sectional view of a divider of the spandrel device, as indicated in FIG. 3.

FIG. 7 is a side elevational of a stained glass bracket device according to the present invention.

FIG. 8 is a broken away perspective view of a portion of a frame member of the stained glass bracket device shown in FIG. 6.

FIG. 9 is a front elevational view of a third embodiment of the spandrel device according to the present invention.

FIG. 10 is a front elevational view of a fourth embodiment of the spandrel device according to the present invention.

FIG. 11 is a front elevational view of a fifth embodiment of the spandrel device according to the present invention.

FIG. 12 is a front elevational view of a sixth embodiment of the spandrel device according to the present invention.

FIG. 13 is a front elevational view of a seventh embodiment of the spandrel device according to the present invention.

FIG. 14 is a front elevational view of a eighth embodiment of the spandrel device according to the present invention.

FIG. 15 is a front elevational view of a ninth embodiment of the spandrel device according to the present invention.

FIG. 16 is a front elevational view of a tenth embodiment of the spandrel device according to the present invention.

### DETAILED DESCRIPTION OF PREFERRED EMBODIMENTS

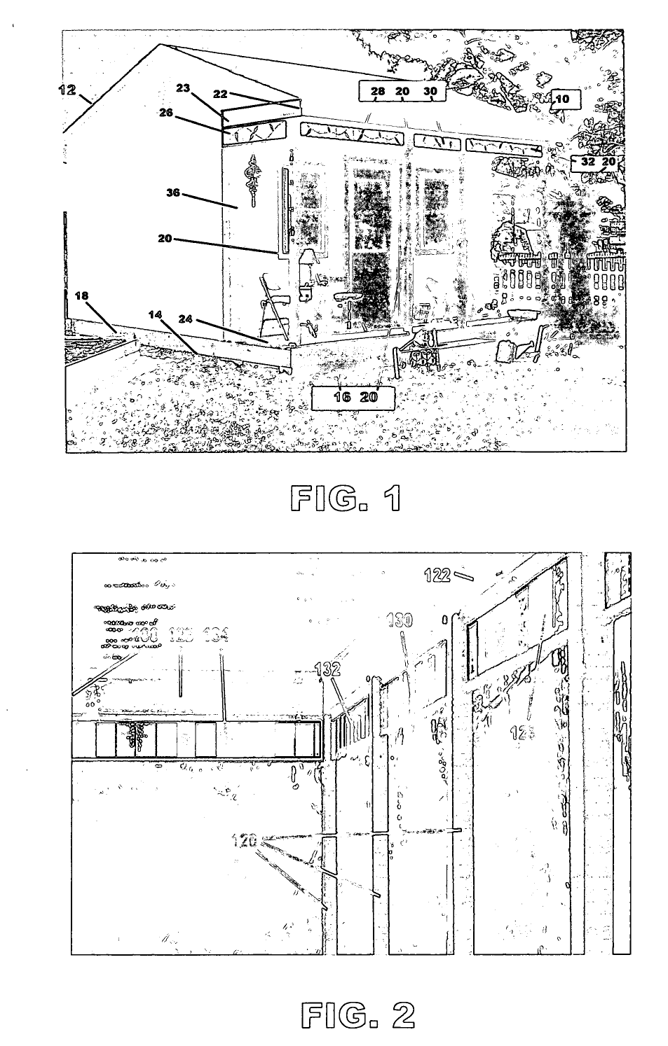

A stained glass porch system 10 according to the present invention is shown in FIG. 1.

The house or building 12 is provided with a porch 14. The porch 14 includes a front elevation 16 and a side elevation 18.

The porch 14 includes four (4) posts 20 supporting a hidden beam 22 and extending upwardly from the porch floor 24. The posts 20 are set vertically, and the beam 22 is set horizontally.

The porch 14 is provided with five (5) spandrel devices 26, 28, 30, 32 (shown) and a right side elevation spandrel device (not shown) according to the present invention. The spandrel device 26 extends from the house facade 34 to the left side post 20 on the side elevation 18 of the house 12. The spandrel devices 28, 30, 32 extend between adjacent posts 20, 20 and contact with the beam 22 on the front elevation of the house 12. Specifically, the upper edge of the spandrel devices 28, 30, 32 contact with the lower edge of beam 22. The spandrel devices 26, 28, 30 are fastened to the posts 20 and beam 22 by mechanical fasteners (e.g. screws, brackets, nails, plates).

The upper edge of the left side elevation spandrel device 16 is in contact with the hidden beam 23. A fifth spandrel (not shown) is provided on the right side elevation of the porch 14. As shown, the spandrel devices 26, 28, 30, 32 have different lengths to accommodate the different distances between adjacent posts 20, 20 on the front elevation of the porch 14, and between the house facade 36 and post 20 on the left side elevation of the porch 14.

The posts 20 can have a wide variety of different spindle shapes or designs, or can be a column. The posts 20 can be made of wood, fiberglass, plastic, concrete or other suitable structural material.

A second embodiment of the stained glass porch system 100 is shown in FIG. 2.

The stained glass porch system 100 is shown with four (4) spandrel devices 128, 130, 132, 134. The spandrel devices 128, 130, 132 extend between adjacent posts 120 on the front elevation of the porch, and the spandrel device 134 extends between the house facade and post 120 on the right side elevation of the porch. As can be seen in FIG. 2, the upper edge of the spandrel devices 128 and 130, 132, 134 are mounted and installed in contact with the lower edge of the beams 122 and 123.

A spandrel device 40 according to the present invention in shown in FIGS. 3-5.

The spandrel device 40 includes a frame 42 having an upper frame member 44, side frame members 46, 48, and a lower frame member 50. The frame members 44, 46, 48, 50 are mitered and joined at the comers 52, 54, 56, 58. The frame 42 is rectangular-shaped and has a low profile (i.e. low ratio of the vertical height to the horizontal length). The frame members 44, 46, 48, 50 are preferably made of rectangular or square cross-sectional polyurethane, vinyl, plastic, wood stock material.

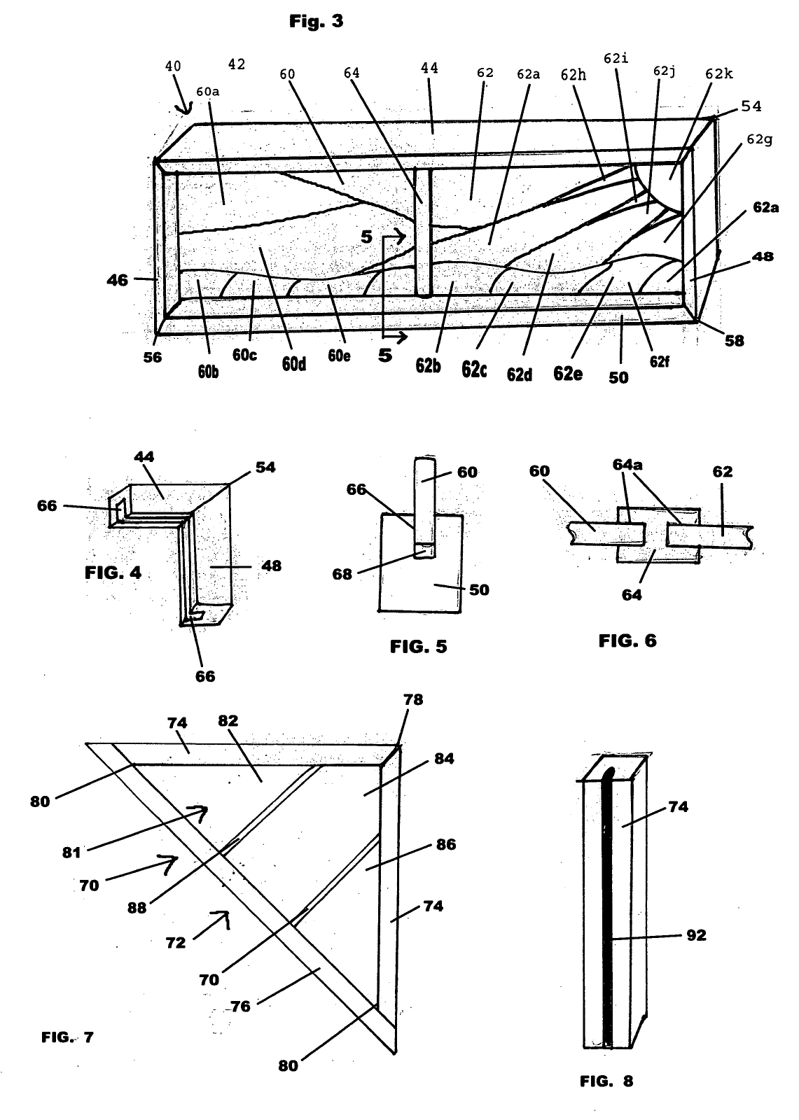

In the embodiment shown in FIG. 3, the stained glass spandrel device 40 includes two (2) stained glass panels 60, 62. The stained glass panels 60, 62 are joined by a vertical oriented divider 64. For example, the divider 64 can be a metal (e.g. zinc) H-shaped channel member having a pair of grooves 64a, as shown in FIG. 6.

The glass panels 60, 62 are shown as being rectangular-shaped, however, the stained glass panels 60, 62 can be square (see embodiment of FIG. 13). In the embodiment shown in FIG. 2, the stained glass panels are each made from a single piece of stained glass. In the embodiment shown in FIG. 3, the stained glass panels 60, 62 are made up of individual stained glass pieces a, b, c, d, e for stained glass panel 60 and 62a, b, c, d, e, f, g, h, i, j, k, l for stained glass panel 62. The individual pieces of stained glass are joined together by sealing, gluing, welding, soldering and/or leading.

The frame members 40, 46, 48, 50 are provided with a groove 66 provided on an inner edge and along the length thereof, as shown in FIG. 4. The groove 66 provides a receiver for the edge of the stained glass panel 60, 62. For example, the stock material can be cut with a circular saw or router to form the groove 66 on one edge thereof prior to assembly into the frame 42. As shown in FIG. 5, a seal 68 is provided in the groove 66 to connect the stained glass panel 60 to the frame member 50 and to protect the edge of the stained glass panel 60 from damage or breakage. For example, a foam or sealant material (e.g. latex, silicone, resin) is provided in the groove 66 prior to installation of the stained glass panel 60. When the foam or sealant cures or hardens, the stained glass panel 60 is bonded to the frame members 50. Preferably, the seal 68 is provided along the entire length of the groove 66 on all four frame members 44, 46, 48, 50.

A stained glass bracket device 70 according to the present invention is shown in FIGS. 7 and 8.

The stained glass bracket device 70 includes a triangular-shaped frame 72 having a pair of equal length frame member 74, 74 connected to a longer frame member 76. Specifically, the frame members 74, 74 are mitered and joined together to form a square corner, and the ends of the frame member 74, 74 are overlapped by the ends of frame member 76 provided a pair of acute angled comers 80, 80. The ends of the frame member 76 protect the ends of the frame members 74, 74 and the hypotenuse edge of the stained glass pieces 82, 84, 86 forming the stained glass panel 81. The dividers 88, 90 join together the stained glass pieces 82, 84, 86.

The frame members 74, 74, 76 are provided with a groove 92 provided on one edge and along the length thereof, as shown in FIG. 8. The groove 92 provides a receiver for the edge of the stained glass panel 81. Further, a foam or sealant bead like that shown in FIG. 5, is provided in the groove 92 to connect, seal and protect the edges of the stained glass panel 81 with the frame members 74, 74, 76.

The spandrel device according to the present invention can have a wide variety of different stained glass panels, as shown in FIGS. 9 to 16.

In the embodiment shown in FIG. 9, the spandrel device 200 is provided with three (3) identical stained glass panels 260, 260, 260 joined together by dividers 264. The stained glass panels 260 include four (4) pieces 260a of textured and colorless glass and a center square piece 260b of colored stained glass.

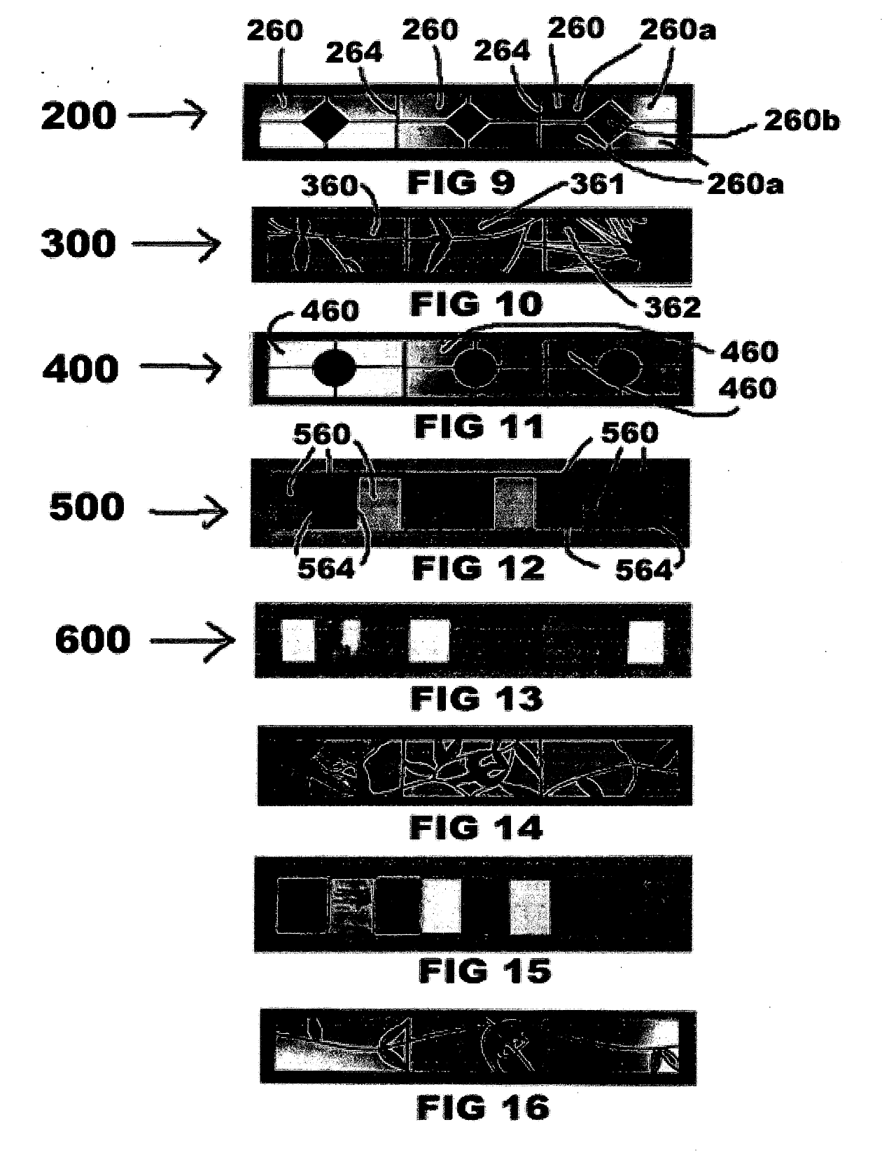

In the embodiment shown in FIG. 10, the spandrel device 300 is provided with three (3) different stained glass panels 360, 361, 362 each having its own unique design. However, the three panels 360, 361, 362 are coordinated in both stained glass design and color to form an overall stained glass design among the three panels 360, 361, 362.

In the embodiment shown in FIG. 11, the spandrel device 400 is provided with three (3) identical stained glass panels 460, 460, 460 each having four separate lightly colored and translucent stained glass pieces and a center circlular stained glass piece.

In the embodiment shown in FIG. 12, the spandrel device 500 is provided with nine (9) rectangular-shaped stained glass panels 560 joined by dividers 564. The stained glass panels 560 are each a single piece of colored stained glass, and the stained glass pieces are different colors from panel-to-panel.

In the embodiment shown in FIG. 13, the spandrel device 600 is provided with eight (8) square stained glass panels and a single rectangular-shaped panel.

An additional three (3) spandrel devices according to the present invention are shown in FIG. 14-16. These provide additional examples of the stained glass panels, dividers and stained glass designs for the spandrel device according to the present invention.

### Construction

The stained glass porch system according to the present invention can be achieved by first constructing a porch having a plurality of vertical posts supporting an upper horizontal beam. The posts can be along a front elevation and/or one or more side elevations of the porch.

After construction of the porch, the spandrel devices according to the present invention are constructed, and then installed or mounted between adjacent posts or the house or building facade and a post, and in contact with the beam. For example, the spandrel devices are constructed to fit exactly between a pair of adjacent posts and in contact with the lower edge of the beam. The spandrel devices are then connected to the post and beam by mechanical fasteners to secure same in place.

I claim:

1. A stained glass porch system, said system comprising:
a porch having a plurality of vertical posts supporting a horizontal beam and defining multiple openings;
a plurality of spandrel devices each mounted within one of said openings extending between a pair of said vertical posts or a building facade and a post, and in contact with a lower edge of said beam, said spandrel devices each comprising:
a low profile rectangular frame including four (4) frame members mitered and joined together at comers of said rectangular frame, said frame members being grooved along the length of one edge to provide a receiver for edges of a plurality of stained glass panels;
a plurality of stained glass panels disposed side-by-side in a horizontal linear array within said rectangular frame;
a seal provided in said grooves of said frame members of said rectangular frame, and provided between edges of said stained glass panels and an inner edges of said grooves; and
a least one vertical divider extending between an upper frame member and lower frame member of said rectangular frame, and connecting adjacent stained glass panels together,
wherein said plurality of spandrels are set at a same height on said porch.

2. A system according to claim 1, wherein said frame members are made from a polyurethane material.

3. A system according to claim 1, wherein said stained glass panels are each defined by a single piece of rectangular-shaped stained glass.

4. A system according to claim 2, wherein adjacent stained glass panels are different colored from panel-to-panel.

5. A system according to claim 2, wherein said stained glass panels are square.

6. A system according to claim 3, wherein said stained glass panels are square.

7. A system according to claim 1, wherein one or more of said stained glass panels have multiple different colored stained glass areas providing a unique stained glass design.

8. A system according to claim 6, wherein adjacent stained glass panels are coordinated in color and design from panel-to-panel to create a coordinated color design to the particular spandrel device.

9. A system according to claim 7, wherein said stained glass panels are leaded stained glass panels.

10. A system according to claim 8, wherein said stained glass panels are leaded stained glass panels.

11. A system according to claim 1, including multiple spandrel devices provided side-by-side on a front elevation of said porch.

12. A system according to claim 1, including multiple spandrels provide on both a front elevation and side elevation of said porch.

13. A system according to claim 1, wherein said rectangular frame is colored coordinated with said posts of said porch.

14. A system according to claim 1, wherein said at least one divider is a metal H-shaped track dividers.

15. A system according to claim 1, including one or more openings provided with a set of triangular-shaped bracket device mounted to a pair of adjacent posts and said beam.

16. A system according to claim 15, wherein each said triangular-shaped bracket devices, includes:
two (2) equal length frame members mitered and joined together to provide a square comer;
a third longer length frame member mitered, overlapping and joining ends of said equal length frame members to form two acute angle corners, said frame members grooved along the length of one edge to provide a receiver for edges of a triangular-shaped stained glass panel; and
a triangular-shaped stained glass panel disposed within said frame members,
wherein said third longer length frame member protects a hypotenuse edge of said stained glass panel.
